(19) United States
(12) Patent Application Publication
(10) Pub. No.: US 2003/0078943 A1
(43) Pub. Date: Apr. 24, 2003

(54) Conduits for multiple data sources

(76) Inventor: Vernon E. McGeorge JR., San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/981,893

(22) Filed: Oct. 19, 2001

(51) Int. Cl. G06F 17/30

(52) U.S. Cl. 707/200

(57) ABSTRACT

A method for managing data from multiple data sources uses conduits to enable one user interface to manage data from multiple data sources, by allowing multiple data sources and/or different versions of a data source to be viewed and managed through a single instance of a user interface. As a result, menus, toolbars and navigational aids may operate across all the data. In addition, the conduits may shield the user interface from the update performance of each data source individually.

### TECHNICAL FIELD

The technical field relates to database management, and, in particular, to multiple data sources management.

### BACKGROUND

Computers are powerful tools for storing and providing access to vast amounts of information. Computer databases are a common mechanism for storing information on computer systems while providing easy access to users. A typical database is an organized collection of related information stored as “records” having “fields” of information. Between the actual physical databases itself and the users of the system, a database management system is typically provided as a software cushion or layer. In essence, the database management system shields the database user from knowing or even caring about underlying hardware-level details. All requests from users for access to the data are typically processed by the database management system. In other words, the database management system provides users with a conceptual view of the database that is removed from the hardware level.

Applications may be built on top of application programming interfaces (API) that present information in the form of tables using a relational database model. Additionally, applications may save data retrieved from an API into a local file or database. However, an application typically does not save data retrieved from a remote database into a copy on a local database.

The relational database model used by many database management systems can manage data from a single source. Faced with multiple data sources, (for example, multiple connections to the same databases or servers via the API, or live connections to databases or servers in conjunction with open copies of previously saved data,) a user typically must launch a completely separate user interface to manage each data source, because the duplicate data from the various sources described above can lead to duplication of database keys used to access and manage the data. This is a violation of the relational database model that cannot be allowed. In order to work with data from multiple data sources, the user must be able to navigate within the user interface (to manage data within a data source) and also navigate between interfaces (to manage data across multiple data sources). Therefore, launching separate user interfaces increases the footprint of the user interface, both in terms of memory used and CPU cycles consumed, as shown in Table 1, while at the same time decreasing the ability of the user to understand and manage data.

TABLE 1

| Instance “Footprint” | Impact | Impact |
|---|---|---|
| contains | CPU utilization | memory utilization |
| A Java virtual machine | Yes | Yes |
| Copies of SGM classes | No | Yes |
| (written in Java language) | | |
| Data specific to clusters, | No | Yes |
| nodes, packages being | | |
| managed | | |
| Misc. overhead | Yes | Yes |

Referring to Table 1, data specific to clusters, nodes, and packages being managed is the only part of this instance footprint that adds value to a user. This data may be shown to the user as a set of tables presented by the service guard manager (SGM) API in the relational database model. The replication of the other parts of the instance footprint, such as the Java virtual machine (VM), the SGM classes, and overhead, consume resources without providing additional value to the user.

### SUMMARY

A method for managing data from multiple data sources using conduits includes maintaining database tables in individual data contexts, ensuring name spaces are unique within each data context, and combining the database tables into larger tables in a display context. The larger tables may contain data from multiple data sources. A user interface can manage the data from multiple data sources through the conduits. In an embodiment, data changes may be propagated transparently and bi-directionally through the conduits to the data contexts and the associated data sources.

The conduits may enable one user interface to manage data from multiple data sources by allowing multiple data sources and/or different versions of a data source to be viewed and managed through a single instance of a user interface. As a result, menus, toolbars and navigational aids may operate across all the data. In addition, the conduits may shield the user interface from updating each data source individually.

### DESCRIPTION OF THE DRAWINGS

The preferred embodiments of a method and apparatus for managing data from multiple data sources using conduits will be described in detail with reference to the following figures, in which like numerals refer to like elements, and wherein:

FIG. 1 illustrates an exemplary method for managing data from multiple data sources using conduits;

FIG. 2 is a flow chart illustrating the exemplary method of FIG. 1 for reading data from multiple data sources using conduits;

FIG. 3 is a flow chart illustrating the exemplary method of FIG. 1 for writing data to multiple data sources using conduits; and

FIG. 4 illustrates exemplary hardware components of a computer that may be used in connection with the method for managing data from multiple data sources using conduits.

### DETAILED DESCRIPTION

A method and apparatus for multiple data source management provides a layer of abstraction, i.e., conduits, between a data model and the presentation of the data to a user. The method applies to service guard manager (SGM) module, but can be equally applied to other database management tools.

A SGM module provides a visual tool to manage entities, such as service guard, service guard oracle parallel server (OPS) edition, metro cluster, continental clusters, and to maintain high availability (HA). Using the SGM module, operators see color-coded, graphically-intuitive icons to get the big-picture view of multiple clusters so that they can proactively manage the clusters, systems (or nodes), and applications. The SGM module enables operators to quickly identify problems and dependencies with drill-down screens for more than one HA cluster, and enables operators to quickly know service guard status, thus minimizing operator training requirements. System administrators can validate the current service guard cluster, node, and package configuration through visualization. The following describes the conduits for multiple data sources in connection with the SGM module. However, one skilled in the art will appreciate that the conduits can be equally applied to other modules or entities having the same or similar functions.

When a data source is open, the data source typically refers to each fundamental element, such as a cluster, a node, or a package, by a unique identifier. In other words, all key fields for the database may be unique in individual data context. However, if data from the individual data context are blended together, or if two data sources are open at the same time, the identifiers of the saved file may be the same as the identifiers in the live connection to the clusters, nodes, and packages. In other words, primary keys of database tables, i.e., name spaces, are no longer unique, violating the relational database model.

The method for managing data from multiple data sources using conduits involves maintaining database tables for each data source in individual data context, and merging the database tables into larger tables in a display context. The method ensures key values within the display data context are unique by appending a source identifier as a key field to the data before combining or updating the database tables in the display context. Thereafter, the SGM module may effectively interact with the display context, and all the key values may remain as unique.

The conduits may enable one user interface to manage data from multiple data sources by allowing multiple data sources and/or different versions of a data source (for example, previously saved copies of the data) to be viewed and managed through a single instance of a user interface. In addition, the conduits may shield the user interface from the update performance of each data source. This functionality may allow for separate connection management from the display of information, and creation of parallel connections to back-end data to increase performance. Back-end data is typically data retrieved from a server, such as a cluster object manager (COM), via an API. For the SGM module specifically, shielding the user interface from the update performance of each data source allows for management of continental clusters, where the data must come from at least two separate data sources.

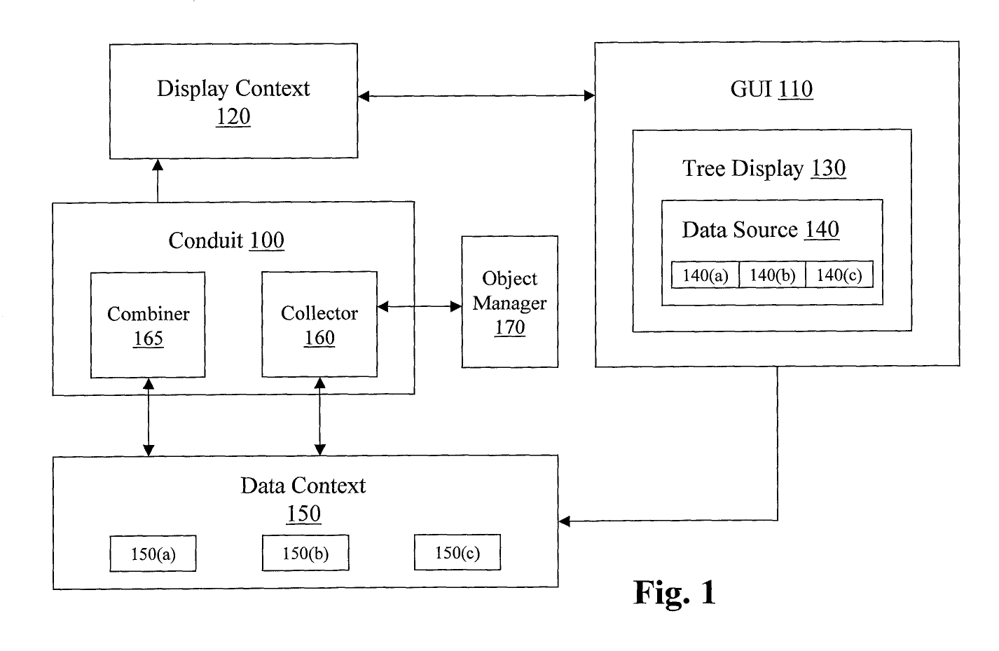

FIG. 1 illustrates an exemplary method for managing data from multiple data sources using conduits. The exemplary method uses conduits 100 to combine data from multiple data sources 140 to be displayed on a single display.

A graphical user interface (GUI) instance 110 typically displays data that the GUI instance 110 observes in a context. The method for managing data from multiple data sources splits this context into a display context 120 and multiple data contexts 150, one per each data source 140. The display context 120 may act as shared data model for use by multiple GUI elements. Separate data contexts 150(a), 150(b), 150(c) is typically required because name spaces may not be unique at the data source level.

Every GUI instance 110 may interact with a display context 120, which drives the GUI instance 110 via tables that the GUI instance 110 contains. The tables are internal data structures from which data is retrieved to draw the GUI elements. The GUI instance 110 is typically a running SGM program that runs in a window frame. The frame may contain GUI elements, such as a title bar, buttons, and a border. Additional GUI elements may be added, such as a menu bar, a tool bar, a split pane, a tree, a map, and a status bar. Each of the GUI elements may interact with the tables as appropriate, and may create appropriate views on the tables in the display context 120.

The GUI instance 110 may have a tree display 130, which may contain one or more data sources 140(a), 140(b), 140(c). The data sources 140(a), 140(b), 140(c) typically contain clusters and unused nodes. Clusters are typically one or more nodes that are configured to run one or more packages. A data source 140 may be either an open file or a logical connection to an object manager 170, such as a cluster object manager (COM). The display for each data source 140 may contain a sub-tree data context 150 that is equivalent to the tree display 130. Each data source 140 in the tree display 130 may correspond to one data context 150. When a user connects to the object manager 170, a list of clusters and unused nodes may be shown on the tree display 130 under a tree element associated with the data source 140. The data from all the data contexts 150(a), 150(b), 150(c) associated with the data sources 140(a), 140(b), 140(c) may be combined by the conduits 160 into one display context 120 to create the tree display 130.

The schema for a number of tables may define two identification (ID) fields, such as Id and Id2, or ObjectId1 and ObjectId2. Before data can be loaded into the main display context 120, the conduit 100 typically appends a source identifier as a key field to the data to uniquely define the data source 140. In other words, the conduit 100 uniquely identifies, as different data sources 140(a), 140(b), 140(c), the two instances of the same open file, or the two connections with the same cluster in scope. For example, a node may appear on the tree display 130 in two places, both of which may have the same “name”. However, the conduit 100 may append two different source identifiers to the nodes, so that the necessary uniqueness of name spaces may be restored before the nodes are merged into the display context 120.

The conduit 100 typically includes a collector 160 and a combiner 165. The collector 160 may retrieve data from a data source 140 and input the data into a data context 150, whereas the combiner 165 may merge all data in the display context 120. Every data context 150 for a logical connection to the object manager 170 may be connected to one or more collectors 160. Each collector 160 may have a physical connection to the object manager 170. Each collector 160 may also be responsible for managing the physical connection, i.e. error reporting and reconnection. In addition, each collector 160 may create views to tables from the object manager 170. When data change events occur, the collector 160 may update the appropriate tables in the data context 150.

When open data sources 140 are connected to by a user interface, the conduit 100 may move data from the data context 150 and associated data sources 140 to the display context 120. The conduit 100 may join the identification of the data sources 140 with the table information from the data context 150, and update the tables in the display context 120. The GUI elements that depend on views against the tables in the display context 120 may be updated automatically. Other GUI elements may need to be updated explicitly after detecting changes.

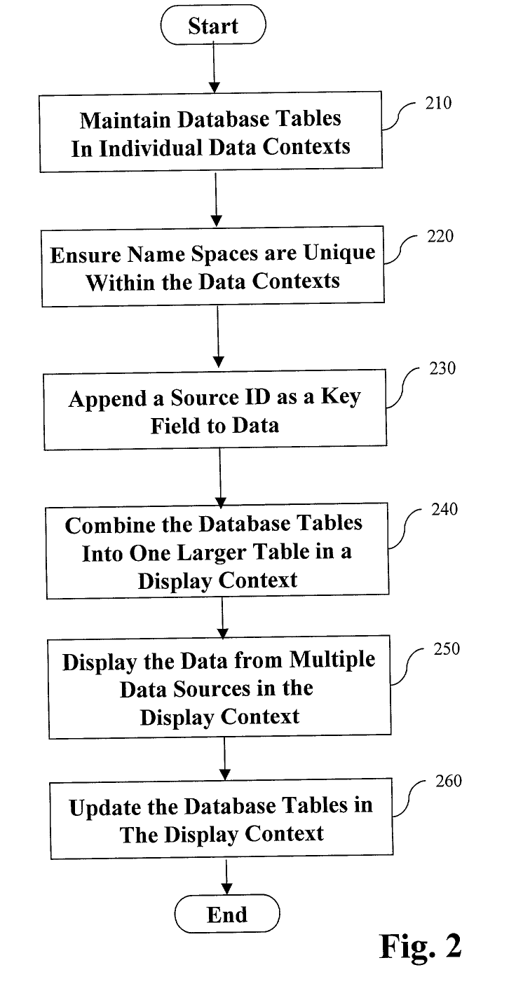

FIG. 2 is a flow chart illustrating the exemplary method for reading data from multiple data sources using conduits 100. First, database tables may be maintained in individual data contexts 150, step 210. The database tables contain data from multiple data sources 140. Next, the conduits 100 may be created to ensure name spaces of the data are unique within the data contexts 150, step 220, by, for example, appending a source identifier as a key field to the data. Next, the database tables may be combined into one larger table in a display context 120, step 240. Data from multiple data sources may be displayed in the display context 120, so that a user interface can display the data from multiple data sources through the conduits 100, step 250. Additionally, the database tables may be updated automatically or explicitly in the display context 120, step 260, thereby shielding the user interface from updating each data source individually.

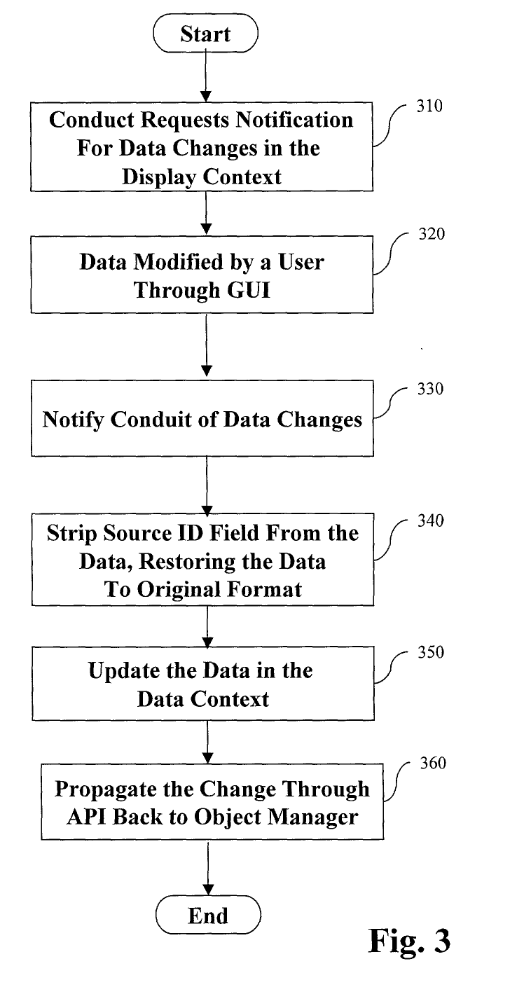

FIG. 3 is a flow chart illustrating the exemplary method for writing data to multiple data sources using conduits 100. First, after data is added to the display context 120, the conduit 100 may request notification of any data changes, step 310. The user may later modify the data through the GUI 110, step 320. After the conduit 100 is notified of a data change, the modified data may be delivered to the conduit 100, step 330. The data typically contains the unique source identifier appended to the data in step 230. Next, the conduit 100 typically strips the unique source identifier from the data, so that the resulting data may be in the same original format. The conduit 100 may then update the data in the data context 150, step 350. The conduit 100 may also send this changed data back to the object manager 170 for propagation back the original source entities, step 360.

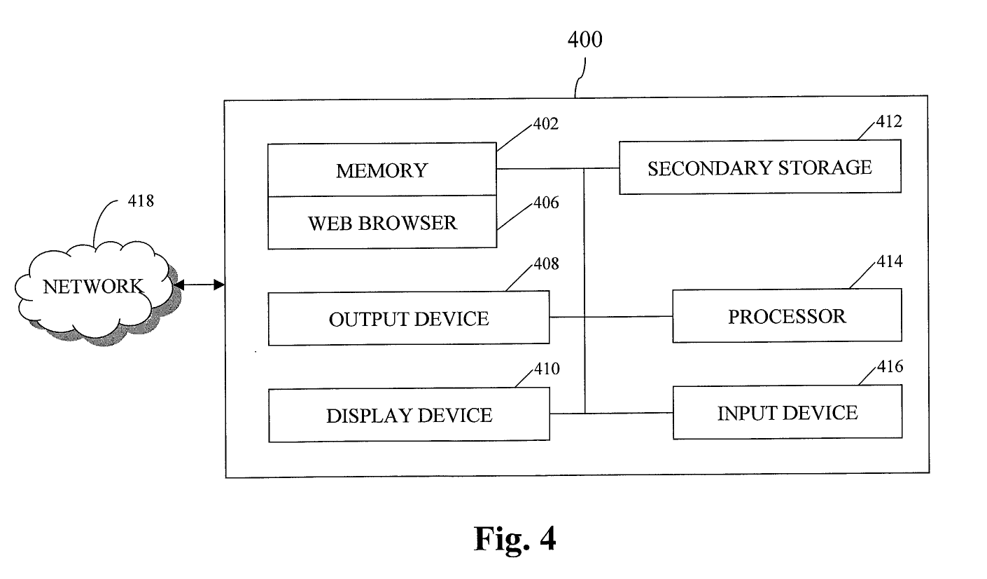

FIG. 4 illustrates exemplary hardware components of a computer 400 that may be used in connection with the method for managing data from multiple data sources using conduits. The computer 400 includes a connection with a network 418 such as the Internet or other type of computer or telephone networks. The computer 400 typically includes a memory 402, a secondary storage device 412, a processor 414, an input device 416, a display device 410, and an output device 408.

The memory 402 may include random access memory (RAM) or similar types of memory. The memory 402 may be connected to the network 418 by a web browser 406. The web browser 406 makes a connection by way of the World Wide Web (WWW) to other computers, and receives information from the other computers that is displayed on the computer 400. Information displayed on the computer 400 is typically organized into pages that are constructed using specialized language, such as HTML or XML. The secondary storage device 412 may include a hard disk drive, floppy disk drive, CD-ROM drive, or other types of non-volatile data storage, and may correspond with various databases or other resources. The processor 414 may execute information stored in the memory 402, the secondary storage 412, or received from the Internet or other network 418. The input device 416 may include any device for entering data into the computer 400, such as a keyboard, keypad, cursor-control device, touch-screen (possibly with a stylus), or microphone. The display device 410 may include any type of device for presenting visual image, such as, for example, a computer monitor, flat-screen display, or display panel. The output device 408 may include any type of device for presenting data in hard copy format, such as a printer, and other types of output devices including speakers or any device for providing data in audio form. The computer 400 can possibly include multiple input devices, output devices, and display devices.

Although the computer 400 is depicted with various components, one skilled in the art will appreciate that the computer 400 can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 400 to perform a particular method.

While the method and apparatus for managing data from multiple data sources using conduits have been described in connection with an exemplary embodiment, those skilled in the art will understand that many modifications in light of these teachings are possible, and this application is intended to cover any variations thereof.

What is claimed is:

1. A method for managing data from multiple data sources using conduits, comprising:
maintaining database tables in individual data contexts, wherein the database tables contain data from multiple data sources;
ensuring name spaces are unique within each data context through conduits; and
combining the database tables into larger tables in a display context,
whereby a user interface can manage the data from multiple data sources through the conduits.

2. The method of claim 1, further comprising displaying the data from multiple data sources in the display context.

3. The method of claim 1, wherein the ensuring step includes appending a source identifier as a key field to the data before combining the database tables in the display context.

4. The method of claim 1, further comprising:
requesting notifications for data changes in the display context by the conduits;
notifying the conduits of the data changes;
updating the data in the data contexts by the conduits, whereby shielding the user interface from updating each data source individually.

5. The method of claim 4, wherein the ensuring step includes appending a source identifier as a key field to the data before combining the database tables in the display context, and wherein the updating step includes striping the source identifier from the data before updating the data context.

6. The method of claim 4, wherein the updating step includes updating automatically elements that depend on views against the database tables in the display context.

7. The method of claim 4, wherein the updating step includes updating explicitly elements that do not depend on views against the database tables in the display context.

8. The method of claim 4, further comprising propagating the data changes through the conduits to the data sources.

9. A system for managing data from multiple data sources, comprising:
one or more data contexts, wherein each data context is devoted to one of multiple data sources;
one or more database tables that contain data from multiple data sources;
a display context that creates views to the one or more database tables; and
a conduit that append a source identifier as a key field to the data before combining the database tables in the display context,
whereby a user interface can manage the data from multiple data sources through the conduit.

10. The system of claim 9, wherein the conduit includes one or more collectors capable of retrieving the data from the data source and inputting the data into the data context associated with the data source.

11. The system of claim 9, wherein the conduit includes one or more combiners capable of merging all data in the display context.

12. The system of claim 9, wherein the conduit has logical connections to the data sources that includes one or more actual connections between individual collectors in the conduit and individual instances of an object manager.

13. The system of claim 9, wherein the conduit requests notifications for data changes in the display context.

14. The system of claim 13, wherein the conduit updates the data in the data contexts after receiving the notifications for the data changes, whereby shielding the user interface from updating each data source individually.

15. A computer readable medium providing instructions for managing data from multiple data sources using conduits, the instructions comprising:
maintaining database tables in individual data contexts, wherein the database tables contain data from multiple data sources;
ensuring name spaces are unique within each data context through conduits; and
combining the database tables into larger tables in a display context,
whereby a user interface can manage the data from multiple data sources through the conduits.

16. The computer readable medium of claim 15, further comprising instructions for displaying the data from multiple data sources in the display context.

17. The computer readable medium of claim 15, wherein the instructions for ensuring include instructions for appending a source identifier as a key field to the data before combining the database tables in the display context.

18. The computer readable medium of claim 15, further comprising instructions for:
requesting notifications for data changes in the display context by the conduits;
notifying the conduits of the data changes;
updating the data in the data contexts by the conduits, whereby shielding the user interface from updating each data source individually.

19. The computer readable medium of claim 18, wherein the instructions for ensuring include instructions for appending a source identifier as a key field to the data before combining the database tables in the display context, and wherein the instructions for updating includes instructions for striping the source identifier from the data before updating the data context.

20. The computer readable medium of claim 15, further comprising instructions for propagating the data changes through the conduits to the data sources.
